(19) United States
(12) Patent Application Publication
(10) Pub. No.: US 2025/0363450 A1
(43) Pub. Date: Nov. 27, 2025

(54) SYSTEM AND METHOD FOR MANAGING A STOCKING OF A WAREHOUSE ON A FARM

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US); Ray Ochsner, Papillion, NE (US)

(73) Assignee: CLAAS Omaha Inc., Omaha, NE (US)

(21) Appl. No.: 19/294,178

(22) Filed: Aug. 7, 2025

Related U.S. Application Data
(63) Continuation of application No. PCT/IB2023/061306, filed on Nov. 9, 2023.

(30) Foreign Application Priority Data
Feb. 9, 2023 (DE) 10 2023 103 208.9

(51) Int. Cl. G06Q 10/087; G06Q 50/02

(52) U.S. Cl. CPC G06Q 10/0872; G06Q 50/02

(57) ABSTRACT

A system and method for managing a stocking of a warehouse on a farm. The system comprises a server, a database, and a computational device. A module for managing the stocking of the warehouse with spare parts and information and/or criteria regarding the stocking of the warehouse are stored in the database. The module is executable by the computational device, with the server hosting the module for the computational device. Upon execution of the module by the computational device, the module is configured to automatically plan, coordinate, and supervise the stocking of the warehouse with spare parts based on the information and/or criteria stored in the database.

### CROSS REFERENCE TO RELATED APPLICATIONS

This application is a continuation-in-part and claims priority to PCT Application No. PCT/IB2023/061306 (published as WO/2024/165906) filed on Nov. 9, 2023, which claims priority to German Patent Application No. 10 2023 103 208.9 filed Feb. 9, 2023, the entire disclosure of both which are hereby incorporated by reference herein. This application is also related to U.S. application Ser. No. ______ (attorney docket no. 15191-24025A (P05768/8)), U.S. application Ser. No. ______ (attorney docket no. 15191-24026A (P05769/8)), U.S. application Ser. No. ______ (attorney docket no. 15191-24027A (P05770/8)), U.S. application Ser. No. ______ (attorney docket no. 15191-24028A (P05771/8)), U.S. application Ser. No. ______ (attorney docket no. 15191-24030A (P05773/8)), U.S. application Ser. No. ______ (attorney docket no. 15191-24031A (P05774/8)), and U.S. application Ser. No. ______ (attorney docket no. 15191-24032A (P05775/8)), each of which are incorporated by reference herein in their entirety.

### TECHNICAL FIELD

The present invention relates to a system for managing a stocking of a warehouse on a farm and a method for managing a stocking of a warehouse on a farm.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Spare parts may be stored in central warehouses of manufacturers, local warehouses of service providers, spare part dealers and/or repair shops spread across a country or region in order to provide spare parts for maintenance and/or repair in the event of a failure of a vehicle.

An essential aspect for operating warehouses is the management of the warehouses, respectively the management of the stock. Spare parts frequently leave the warehouses, requiring the warehouses to be restocked. One solution is to have systems that automatically track a stock level of a warehouse and place an order for restocking the warehouse if a need is identified. For example, WO 2018/187788 A1 discloses a method for tracking a stock level within a store. The method includes, at a robotic system, navigating along a first inventory structure in the store, broadcasting radio frequency interrogation signals according to a first set of wireless scan parameters, and recording a first set of wireless identification signals returned by radio frequency identification tags coupled to product units arranged on the first inventory structure, generating a first list of product units arranged on the first inventory structure based on the first set of wireless identification signals, detecting a first product quantity difference between the first list of product units and a first target stock list assigned to the first inventory structure by a planogram of the store and generating a stock correction prompt for the first inventory structure in response to the first product quantity difference.

Generally, the location of warehouses, either central warehouses or local warehouses, across the country is chosen in such a way that a connection to existing logistics networks for part distribution is possible. For central warehouses, often a location is chosen which ensures that part distribution to different local warehouses is possible with the least possible expenditure of time and resources. When one or more local warehouses run out of parts, it is therefore possible to restock the local warehouses according to their defined target stock as soon as possible. Part distribution networks comprising one or more central warehouses and many local warehouses distributed across the country being connected to existing logistics networks also may guarantee a supply of parts when one local warehouse runs out of stock.

### BRIEF DESCRIPTION OF THE DRAWING

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example system for managing a warehouse on a farm in which spare parts for one or more agricultural machines of a fleet of agricultural machines are stocked.

### DETAILED DESCRIPTION

As discussed in the background, spare parts may be stored in a variety of places as a part distribution network. However, there are countries or regions where establishing such parts distribution networks may be impossible due to a lack of infrastructure and logistics. This may especially be a problem in the field of agriculture. Areas that are cultivated are typically located in regions with little or no infrastructure and logistics. For example, in countries like the United States, there are regions almost completely formed by fields and farms cultivating lots of hectares of farmland. When it comes to maintenance service availability and/or spare part availability for agricultural machines, there is often few service providers, spare part dealers and/or dealer ships of manufacturers that are located in these regions, with distances of hundreds of kilometers in between these facilities and the farms. To address these challenges, some manufacturers of spare parts and/or agricultural machines sell warehouses to their customers for stocking spare parts directly on the farm. The customer is able to perform maintenance work and/or repair work directly on the farm having spare parts for those parts of the agricultural machines that are generally subject to severe wear or failure during operation.

Stocking and replenishing of these warehouses may typically be performed by manual operation. The user of the warehouse telephones the service provider, spare part dealer or manufacturer and places an order for spare parts that will most probably suffer from severe wear or failure during the harvest season/period. The service provider, spare parts dealer or manufacturer plans, instructs and triggers the order placed so that the required spare parts will be procured and delivered to the warehouse. Often, the planning and instruction of the order placed on service provider's, spare part dealer's and/or manufacturer's side is cumbersome and complex. Moreover, significant time may pass between placing the order and the arrival of the spare parts on the farm. This may be detrimental as the user of the warehouse has a high interest in an exchange of the part as quickly as possible as machine downtime immediately results in significant economic losses. Further, the user may store excessive and unnecessary stock. Thus, a warehouse on the farm may complicate matters, including when the warehouse is located at or on or proximate to (e.g., less than ½ mile, less than 1 mile, etc.) from the farm. As one example, replenishing the spare part(s) of the warehouse on the farm may comprise sending (such as automatically sending via drones or self-driving vehicles) spare part(s) from a manufacturer directly to the warehouse on the farm and/or sending (such as automatically sending via drones or self-driving vehicles) spare part(s) from another warehouse (such as a central warehouse or storage facility, a neighboring warehouse farm, etc.) to the warehouse on the farm. As discussed further below, the system may automatically determine: how much to stock of the spare part(s) at the warehouse on the farm; the timing of when to stock the spare part(s) at the warehouse on the farm; and the transport (such as automatic transport) of the spare part(s) to the warehouse on the farm in order reconcile when and how many spare parts are needed on the farm. In this regard, managing the warehouse on the farm may add a layer of complexity not found when managing a centrally located warehouse.

Therefore, in order to overcome one or more shortcomings discussed herein, a system and method are disclosed that enable an easy and efficient management of a stocking of a warehouse on a farm with a focus on serving the needs of a user of the warehouse with reduced or the least expenditure of time and resources as possible.

In one or some embodiments, a system is disclosed for managing a stocking of a warehouse on a farm with spare parts for at least one agricultural machine of a fleet. The system may comprise at least one server (such as a single server), at least one database (such as a single database), and at least one computational device (such as a single computational device), wherein the at least one server, the at least one database and the at least one computational device communicate (e.g., wired and/or wirelessly) with each other via one or more networks. At least one module for managing the stocking of the warehouse with spare parts and information and/or criteria regarding the stocking of the warehouse may be stored in the database. The at least one module is executable by the at least one computational device. The at least one server may host the module for the computational device. Upon execution of the module by the computational device, the module is configured to plan, to coordinate and to supervise the stocking of the warehouse with spare parts based on the information and/or criteria stored in the database.

As indicated above, warehouses on farms are often used in countries or regions with little to no logistical infrastructure but may comprise many hectares of agricultural land cultivated by farmers with large fleets of machinery. The efficient organization of a stocking process is, therefore, an essential aspect to manage warehouses directly on the farm in such countries or regions to give to the farmer the guarantee that an agile maintenance service and/or repair service is possible during different time periods in a year. The challenge of having a poor infrastructure to perform logistic operations may require efficient planning, coordinating and supervising of the stocking with the least involvement of the farmer as the farmer's focus is clearly on cultivating the fields. An efficient management of stocking the warehouse may therefore be key to assisting farmers. In this regard, the disclosed system and method may provide a holistic approach to managing the stocking of a warehouse on the farm with different spare parts taking into account some or all players of the global ecosystem for operating such a warehouse. As the system operates basically on a digital level, which may ensure a rapid exchange and processing of a variety of information and/or criteria, managing the stocking is contemplated as efficient as possible with less (or the least) involvement of the user of the warehouse. As such, the user may be relieved of time-consuming tasks to keep track of the stock of the warehouse. So that, the method and system may offer an all-round package that may ensure that the machines are always ready for operation such that the user may focus on the task to keep the business running as economically as possible.

In one or some embodiments, the module is configured to plan, to coordinate and to supervise the stocking of the warehouse with spare parts based on an initial stock of spare parts in the warehouse to secure operation of the at least one agricultural machine during a predetermined time period, such as a harvest season or an entire calendar year. The module may be configured to automatically determine the initial stock based on the information and/or criteria regarding the stocking of the warehouse.

In one or some embodiments, the determination and usage of an initial stock for the warehouse may ensure that the planning, coordinating and supervising of the stocking is always based on the specific spare part configuration the user needs. Spare parts that are not relevant for operating the agricultural machines of the user do not need to be taken into account for the management of the stocking process. Having a solid basis to manage the stocking may permit the use of the available resources as efficiently as possible and to exclude incorrect orders of spare parts.

In one or some embodiments, the module is configured to generate at least one action routine (such as an automatic action routine) for stocking the warehouse with spare parts. The action routine may comprise a list of spare parts needed for the warehouse and procedural instructions to procure spare parts contained in the list (e.g., a list that is manually procured and/or a list that is automatically executed by one or more electronic devices, such as autonomous robot(s), to automatically obtain one, some or all of the items on the list). In one particular example, responsive to generating the list of spare parts (whether fully automatically, partially automatically, or entirely manually), obtaining the spare parts from the list may be performed at least partly automatically (such as fully automatically). In one particular example, automated vehicles (such as self-driving vehicles and/or drones) may be used in order to obtain the spare parts from the list. Further, the module may be configured to generate the action routine based on the information and/or criteria regarding the stocking of the warehouse.

In one or some embodiments, predetermined action routines (such as predetermined automatic action routines) may be executed responsive to automatically determining a need, with the action routines being stored in the database, which may permit automatic and dynamic reacting to changing circumstances in an agile manner. For example, responsive to automatically determining the stock of the warehouse and/or to a change in the stock due to an entry or dispatch of spare parts, the most appropriate action routine for automatically serving the specific needs of a specific user having a specific requirement profile may be automatically chosen and automatically executed by module. In particular, responsive to automatic analysis of the stock of the warehouse and/or automatic analysis to determine the change in the stock due to an entry or dispatch of spare parts, one or more appropriate actions, such as one or more automatic actions, may be automatically executed or automatically controlled by the module.

In one or some embodiments, the action routine may be automatically generated based on spare part availability in a vicinity of the warehouse. In turn, the automated vehicle(s) may automatically transport from the vicinity of the warehouse (e.g., another storage facility proximate to or in the vicinity of the warehouse) to the warehouse.

Taking into account spare part availability may serve to generate and select the most suitable procedural instructions that may take less time (such as the shortest possible time) to automatically procure the spare parts needed to stock the warehouse of the user. Unnecessarily long transportation times due to driving to spare part storages not being the nearest ones to the warehouse may, thus, be avoided.

In one or some embodiments, the module is configured to automatically monitor an entry of spare parts in the warehouse and automatic dispatch of spare parts out from the warehouse. Specifically, upon dispatch of spare parts from the warehouse the module may be automatically configured to instruct and trigger the procedural instructions to procure spare parts.

In one or some embodiments, the module is configured to automatically modify the action routine upon dispatch of spare parts out of the warehouse.

Monitoring the movement of spare parts may improve the reaction time of the system and the selection of the most appropriate action routine for serving the specific needs of a specific user having a specific requirement profile. The system may be able to react automatically at short notice to changing circumstances influencing the stocking process of the warehouse by automatically modifying its action routines.

In one or some embodiments, the module is configured to automatically instruct and trigger the procedural instructions to procure spare parts upon reception of a request for spare parts initiated by a user of the warehouse and/or the at least one agricultural machine.

The possibility to instruct or trigger procedural instruction based on received requests may provide, in addition to the holistic management approach, the ability to respond to individual requirements and, thus, to take individual preferences of the user into account.

In one or some embodiments, the module is configured to automatically monitor a wear condition of the at least one agricultural machine based on the information and/or criteria regarding the stocking of the warehouse. The module may be configured to automatically generate the action routine based on the automatically monitored wear condition of the at least one agricultural machine.

Monitoring the wear condition of the one or more agricultural machines may enable implementation of automatic predictive capability. In particular, the module may be able to automatically predict end of lifetime and/or failure of parts based on the monitored wear condition and to automatically generate specific action routines to deal with such circumstances. For example, automatic pre-ordering spare parts (and potentially automatically retrieving and/or transporting) already at a point in time when the part is still in operation and not yet close to end of lifetime or failure is possible. When the part needs to be exchanged, the respective spare part may already be stored in warehouse. Immediate maintenance or repair is, thus, possible and machine downtime may be significantly reduced.

In one or some embodiments, the module is configured to automatically generate the action routine according to the objective that a procurement of spare parts is guaranteed within a predetermined timeframe.

In one or some embodiments, the module is configured to automatically generate the action routine according to the objective that a procurement of spare parts is guaranteed within less than one working day.

In one or some embodiments, the module is configured to automatically generate the action routine according to the objective that a procurement of spare parts is guaranteed within less than half a working day.

In one or some embodiments, the module is configured to automatically generate one or more different action routines for stocking the warehouse with spare parts. The one or more different actions routines may differ from each other in one or both of the list of spare parts needed for the warehouse and/or the procedural instructions to procure spare parts of the list of spare parts. In particular, each action routine may be designed for a specific time period. The specific time periods may be any one, any combination, or all of a pre-harvest period, a harvest period and a post-harvest period.

In one or some embodiments, the procedural instructions of the action routine for the harvest period may be designed under the premise that procurement of spare parts is performed faster than in the pre-harvest period and post-harvest period.

As indicated, the user may have a high interest in an exchange of a part as quickly as possible as machine downtime may immediately result in significant economic losses, especially during the harvest season. By giving the user the assurance that spare part procurement is performed within a short time, even in countries or regions with little or no logistics infrastructure, and at different speeds depending on the time period not only operation of the machines is secured, but rather trust and commitment of the user is significantly increased as the service provider, spare part dealer and/or manufacturer makes all the resources available so that the user is supported in the best possible way to achieve economic success.

In one or some embodiments, the information and/or criteria regarding the stocking of the warehouse on the farm may be related to any one, any combination, or all of the warehouse on the farm itself, the at least one agricultural machine on the farm, at least one central storage for spare parts, at least one neighboring warehouse for spare parts on a neighboring farm, part runners, or drones for transportation of spare parts between different facilities and entities.

In one or some embodiments, any one, any combination, or all of the warehouse on the farm, the at least one agricultural machine on the farm, the at least one central storage, the at least one neighboring warehouse, the part runners or the drones may communicate (e.g., wired and/or wirelessly) with one another, and may communicate (e.g., wired and/or wirelessly) with any one, any combination, or all of the server, the database, or the computational device via the network to provide the respective information and/or criteria regarding the stocking of the warehouse to the database for storing the same.

In one or some embodiments, the information and/or criteria for managing the warehouse on the farm may comprise any one, any combination, or all of the following: information regarding a geographic position and/or an actual stock of the warehouse on the farm; criteria regarding the stock of the warehouse on the farm; information regarding a configuration of the at least one agricultural machine on the farm; information regarding an operation of the at least one agricultural machine on the farm; information regarding crops harvested on the farm by the at least one agricultural machine; information regarding agronomic conditions on the farm at the geographical position of the warehouse; information regarding climatic conditions on the farm at the geographical position of the warehouse; information regarding a geographical position and/or an actual stock of the at least one central storage; information regarding a geographical position and/or an actual stock of the at least one neighboring warehouse; or information regarding a geographical position, an availability and/or a capacity of the part runners and/or the drones.

In one or some embodiments, at least some of the information and/or criteria for managing the warehouse on the farm is definable by any one, any combination, or all of a user of the warehouse on the farm, a service provider, a spare part dealer, a manufacturer of spare parts, or the at least one agricultural machine on the farm. In one or some embodiments, defining the information and/or criteria may be performed via the computational device and/or at least one user end device communicatively connectable to one or more of the server, the database, or the computational device.

Consideration of different information and/or criteria related to the different players of the global ecosystem for operating the warehouse on the farm may increase the accuracy and efficiency in managing the stocking of the warehouse on the farm. Moreover, consideration of a set of information and/or criteria may enable the module to perform at least some of the functions for managing the warehouse on the farm essentially autonomously, meaning without any or with a reduced or the least-possible involvement of the user.

In one or some embodiments, the at least one user end device is configured to interact with the module via an application configured to execute on the at least one user end device.

Further, in one or some embodiments, a method is disclosed for managing a stocking of the warehouse on a farm with spare parts for at least one agricultural machine of a fleet using a system. The system may comprise a server, a database, and at least computational device, wherein the server, the database, and the at least computational device communicate (e.g., wired and/or wirelessly) with each other via one or more networks. A module for managing the stocking of the warehouse on the farm with spare parts and information and/or criteria regarding the stocking of the warehouse on the farm are stored in the database, wherein the module may be executable by the at least one computational device. The server may host the module for the at least one computational device. Upon execution of the module by the at least one computational device, a stocking of the spare parts in the warehouse on the farm is automatically planned, automatically coordinated and automatically supervised based on the information and/or criteria stored in the database. The features defined herein with regard to the system are equally applicable to the method.

In one or some embodiments, to ensure that the spare parts are also available, the system may automatically plan and automatically coordinate the management of the spare parts, including automatically assembling the parts stock stored in the respective warehouses on respective farms in such a way to solve the problems that predominantly arise in a respective region, either by already having the requisite spare parts in stock and/or by automatically organizing their procurement from central warehouses. In one or some embodiments, the system may automatically factor region-specific requirements, such as the cultivation of wear-intensive grain/crop types, when is the harvest, etc. in automatically managing the procurement, storage and/or transportation of the spare parts.

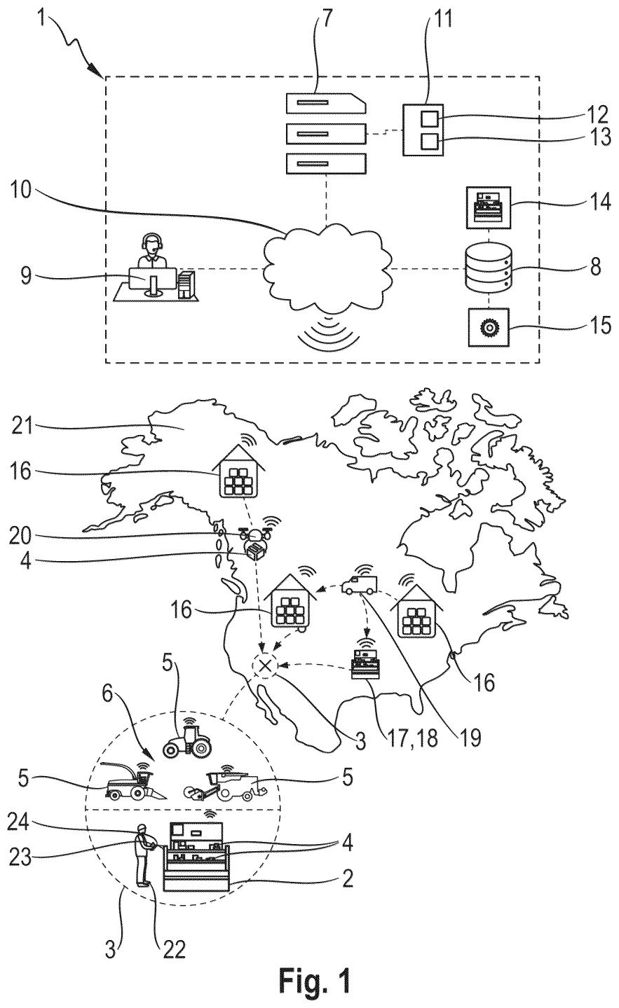

Referring to the FIGURE, FIG. 1 illustrates a system 1 for managing the stocking of a warehouse 2 on a farm 3 with spare parts 4 for one or more agricultural machines 5 of a fleet 6 of agricultural machines 5. The fleet 6 of agricultural machines 5 may comprise one or more tractors, one or more forage harvesters, one or more combine harvesters, one or more agricultural balers, or the like.

The system 1 may comprise at least one server (such as server 7), at least one database (such as database 8), and at least one computational device (such as computational device 9), which may comprise a personal computer, tablet, a smartphone, or the like and which may be operated by a service provider, a spare part dealer, a manufacturer of spare parts 4 and/or the one or more agricultural machines 5 or the like. The server 7, the database 8 and the computational device 9 may communicate (e.g., wired and/or wirelessly) with each other via one or more networks, such as network 10. The network 10 may thus enable an exchange of information and data between the different devices 7, 8, 9.

The server 7 may comprise a processing device 11, which may enable processing of the data and information exchanged between the server 7, the database 8 and/or the computational device 9. The processing device 11 may comprise any type of computing functionality, such as at least one processor 12 (which may comprise a microprocessor, controller, PLA, or the like) and at least one memory 13. The memory 13 may comprise any type of storage device (e.g., any type of memory). Though the processor 12 and the memory 13 are depicted as separate elements, they may be part of a single machine, which may include a microprocessor (or other type of controller) and a memory. Alternatively, the processor 12 may rely on memory 13 for all of its memory needs.

The processor 12 and memory 13 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the processing device 11 which may comprise the at least one processor 12 and the at least one memory 13 may be applied to other devices, such as the computational device 9 mentioned above.

A module 14 for automatically managing the stocking of the warehouse 2 on the farm 3 may be stored in the database 8 and may be configured for execution by the computational device 9. The server 7 may host the module 14 for the computational device 9. Upon execution of the module 14 by the computational device 9, the module 14 may be configured to automatically plan, automatically coordinate, and automatically supervise the stocking of the warehouse 2 with spare parts 4. Execution of and interaction with the module 14 by the computational device 9 is possible, for example, via an application which is configured to run on the computational device 9. For automatically managing the stocking of the warehouse 2 with spare parts 4, the module 14 may use computational resources provided by one or more internal processing devices of the computational device 9 and/or computational resources provided by the processing device 11. To manage the stocking of the warehouse 2 with spare parts 4, the module 14 may be configured to automatically access specific data. Such data are information and/or criteria 15 regarding the stocking of the warehouse 2 on the farm 3, the information and/or criteria 15 being stored in the database 8. To enable the module 14 to manage the stocking of the warehouse 2 the information and/or criteria 15 may be processed by the one or more internal processing devices of the computational device 9 and/or the processing device 11. The processing devices may use different methods or algorithms for processing the information and/or criteria 15 for the sake of automatically planning, automatically coordinating and automatically supervising the stocking of the warehouse 2 with spare parts 4. Some or all of these methods or algorithms may be based on artificial intelligence (AI). In one or some embodiments, the processing is based on remedies or options automatically provided by a neural network.

To automatically manage the stocking of the warehouse 2 efficiently and accurately, information from the global ecosystem may be considered. The information may comprise information for operating the warehouse 2, such as different facilities and/or entities involved in an operation cycle of the warehouse 2. Therefore, the information and/or criteria 15 regarding the stocking of the warehouse 2 may be related to any one, any combination, or all of: one or more warehouses 2; the one or more agricultural machines 5 of the fleet 6; one or more central storages 16 for spare parts 4; one or more neighboring warehouses 17 for storing spare parts 4 on neighboring farms 18; part runners 19 for transportation of spare parts 4 between different facilities and entities; or drones 20 for automatic transportation of spare parts 4 between different facilities and entities. Part runners 19 may be vehicle guides by drivers between the different facilities and entities to transport spare parts 4 and/or autonomous vehicles guided between the different facilities and entities to transport spare parts 4. The different facilities and entities may be distributed across a country 21 or region, as illustrated in FIG. 1.

To provide the respective information and/or criteria 15 regarding the stocking of the warehouse 2 the warehouse 2, any one, any combination, or all of the one or more agricultural machines 5 of the fleet 6, the one or more central storages 16, the one or more neighboring warehouses 17, the part runners 19, or the drones 20 may communicate (e.g., wired and/or wirelessly with any one, any combination, or all of the server 7, the database 8, or the computational device 9 via one or more networks, such as the network 10, in order to provide the respective information and/or criteria 15 regarding the stocking of the warehouse 2 to the database 8 for storing the same. In one or some embodiments, there may be no need for a direct communication between the respective facilities and entities and the database 8 to store the information and/or criteria 15. Rather, the information and/or criteria 15 may be automatically delivered to the database 8 via the server 7 and/or the computational device 9. Moreover, the information and/or criteria 15 regarding the stocking of the warehouse 2 may not necessarily be provided directly by the facilities and entities mentioned before. Rather, the information and/or criteria 15 may be provided by a user 22 of the warehouse 2, service providers, spare part dealers, manufacturers of spare parts 4 and/or agricultural machines 5 or the like, for example via the computational device 9 and/or one or more user end devices 23, the one or more user end devices 23 in communication with the server 7, the database 8 and/or the computational device 9. In other words, the user 22 of the warehouse 2, service providers, spare part dealers, manufacturers or the like may define at least some of the information and/or criteria 15 regarding the stocking of the warehouse 2, such as via the computational device 9 and/or the one or more user end devices 23.

The information and/or criteria 15 regarding the stocking of the warehouse 2 may comprise information regarding any one, any combination, or all of a geographic position of the warehouse 2, an actual stock of the warehouse 2, criteria regarding the stock of the warehouse 2 (e.g., any one, any combination, or all of: spare part type criteria, spare part amount criteria, time period criteria, replenishment cycle criteria, replenishment time criteria or the like), information regarding a configuration of the one or more agricultural machines 5 of the fleet 6, information regarding an operation of the one or more agricultural machines 5 of the fleet 6, information regarding crops harvested by the one or more agricultural machines 5 of the fleet 6, information regarding agronomic conditions at the geographical position of the warehouse 2 (e.g., any one, any combination, or all of: soil information, crop information, yield information, area information or the like), information regarding climatic conditions at the geographical position of the warehouse 2 (e.g., any one, any combination, or all of: humidity information, temperature information, solar radiation information, wind speed information or the like), information regarding a geographical position of the one or more central storages 16, information regarding an actual stock of the one or more central storages 16, information regarding a geographical position of the one or more neighboring warehouses 17, information regarding an actual stock of the one or more neighboring warehouse 17, information regarding a geographical position of the part runners 19, information regarding an availability of the part runners 19, information regarding a capacity of the part runners 19, information regarding a geographical position of the drones 20, information regarding an availability of the drones 20, or information regarding a capacity of the drones 20.

To provide a holistic management approach for stocking the warehouse 2 with spare parts 4, the module 14 may be configured to automatically plan, automatically coordinate and automatically supervise the stocking of the warehouse 2 with spare parts 4 based on an initial stock of spare parts 4 in the warehouse, the initial stock of spare parts 4 being automatically compiled to secure operation of the one or more agricultural machines 5 of the fleet 6 during a time period. The time period may be a harvest season or an entire calendar year. The initial stock of spare parts 4 of the warehouse 2 may be automatically determined by the module 14 based on the information and/or criteria regarding the stocking of the warehouse 2. For example, the initial stock of spare parts 4 may be based on a stock of spare parts 4 automatically recommended to be stocked in the warehouse 2 to secure operation of the one or more agricultural machines 5 of the fleet 6 during the time period. Depending on the time period defined, there may be different automatic recommendations for packages of spare parts 4 to stock in the warehouse 2 as an initial stock. The recommendation may be automatically made by the module 14 and/or any other module stored in the database 8 and configured to automatically manage the warehouse 2 and/or facilities or entities of the global ecosystem for operating the warehouse 2. In this regard, responsive to the automatic recommendation, one or more automatic actions may be performed including any one, any combination, or all of: automatically ordering spare part(s) 4; automatically transporting spare part(s) 4 (e.g., via drone and/or automated vehicles); automatically transporting the spare part(s) 4 into and/or within and/or from the warehouse (e.g., automatically unloading, via robots, the spare part(s) 4 from a loading dock into the warehouse; automatically moving, via robots, the spare part(s) 4, within the warehouse; automatically moving, via robots, the spare part(s) 4 to the loading dock of the warehouse in order to load onto autonomous vehicles or drones; automatically controlling drones and/or autonomous vehicles to transport the spare part(s) 4 from the warehouse).

To efficiently automatically plan, automatically coordinate and automatically supervise the stocking of the warehouse 2 it may be beneficial to have specific actions routines which may represent a kind of plan for actions to be automatically taken to automatically manage the stocking of the warehouse 2. In more detail, the module 14 may be configured to automatically generate one or more such action routines for stocking the warehouse 2 with spare parts 4. Each action routine may comprise a list of spare parts 4 needed for the warehouse 2 and procedural instructions to procure spare parts 4 contained in the list of spare parts 4 needed. Generation of the one or more action routines via the module 14 may be performed while factoring in the information and/or criteria 15 regarding the stocking of the warehouse 2. In particular, the action routines may be automatically generated by the module 14 based on the information of spare part availability in the vicinity of the warehouse 2. Such a nearby spare part availability, for example, may be dependent on information regarding the geographic positions and the actual stock of central storages 16 and/or neighboring farms 18.

Apart from determining such action routines to efficiently automatically plan, automatically coordinate and automatically supervise the stocking of the warehouse 2, the module 14 may further be configured to automatically monitor an entry of spare parts 4 in the warehouse and an automatic dispatch of spare parts 4 out of the warehouse 2. Upon automatic dispatch of spare parts 4 out of the warehouse 2, the module 14 may automatically instruct and automatically trigger the procedural instructions to procure spare parts 4 defined in a specific action routine. Such a procedure may automatically be performed by the module 14 automatically upon dispatch of spare parts 4 out of the warehouse 2. Alternatively or in addition hereto, the module 14 may be configured to automatically instruct and automatically trigger the procedural instructions to procure spare parts 4 upon reception of a request for spare parts 4. The request may be initiated by the user 22 of the warehouse and/or by the one or more agricultural machines (e.g., an automatic request from a respective agricultural machine), being able to communicate with the module 14 via the network 10 to transmit the request. The module 14 may be further configured to automatically modify the action routines upon dispatch (such as automatic dispatch) of spare parts 4 out of the warehouse 2, for example if stock levels of central storages and/or neighboring warehouses 17 and/or position, availabilities and/or capacities of part runners 19 and/or drones have been modified meanwhile. Apart from monitoring spare part entry and dispatch, the module 14 may be configured to automatically monitor the movement of spare parts 4 between the different facilities and entities in general to get a global overview of the routes spare parts 4 take for the sake of optimization.

To assist the module 14 in automatically generating, automatically instructing or automatically triggering the action routines, one or more user end device 23 may comprise a sensor arrangement 24 for automatic identification of spare parts 4 being moved between the different facilities and entities of the global ecosystem for operating the warehouse 2. Alternatively or in addition, the warehouse 2 itself and/or the computational device 9 may comprise a sensor arrangement 24 for automatic identification of spare parts 4 being moved between the different facilities and entities. Via the sensor arrangement(s) 24, it may therefore be possible to automatically provide the module 14 with the ability to automatically track the different movements of the spare parts 4 during a procurement process, a delivery process and/or a usage process. This configuration may support the module's function of automatically coordinating and automatically supervising the stocking of the warehouse 2 with spare parts 4.

Automatic identification of the spare parts 4 being placed in the warehouse 2 and/or being dispatched out of the warehouse 2 may be performed in different ways. In one embodiment, the spare parts 4 may comprise identification tags which may be readable by the sensor arrangement(s) 24. Such identification tags may be RFID-tags, QR-codes, barcodes or the like. Alternatively, the sensor arrangement(s) 24 is configured to identify the spare parts 4 by means of image recognition. Image recognition may be based on classical object recognition methods or algorithms, such as a watershed transformation, an edge detection, histogram methods, eigenspace methods or the like. Still alternatively or in addition, image recognition may be based on adaptive object recognition algorithms, for example those based on neural networks. The sensor arrangement(s) 24 may comprise a processing device which enables identification of the spare parts 4 regardless of the method used for identification. Regarding the configuration of such processing device, reference is made to the processing device 11 of the server 7.

Generating the one or more action routines for automatically stocking the warehouse 2 with spare parts 4 may be performed under a predictive premise. In more detail, the module 14 may be configured to automatically monitor a wear condition of the one or more agricultural machines 5, such as the different parts used in the one or more agricultural machines 5, based on the information and/or criteria 15 regarding the stocking of the warehouse 2. The data received by automatically monitoring the wear condition may be used to automatically generate the action routines for stocking the warehouse 2 with spare parts 4. In particular, the module 14 may be configured to automatically predict end of lifetime and/or failure of parts of the one or more agricultural machines 5 based on the monitored wear condition and to automatically generate the one or more action routines dependent on this prediction. This procedure may enable, for example, to automatically pre-order spare parts 4 (and optionally automatically transport via drone and/or autonomous vehicle) already at a point in time when the part on the agricultural machine 5 is still in operation and not yet close to end of lifetime or failure. However, when the part needs to be changed, the spare part 4 necessary may already be part of the stock of the warehouse 2 so that a replacement may be immediately performed.

In one or some embodiments, essential for the user 22 of the warehouse 2 may be a quick procurement of spare parts 4 as machine downtime will result in significant economic losses. Therefore, the module 14 may be configured to automatically generate the one or more action routines according to the objective that a procurement of spare parts 4 may be guaranteed within a predetermined timeframe. Such a timeframe may be within less than one working day, such as within less than half a working day. Besides, it may be beneficial to generate different action routines depending on a specific time. Therefore, the module 14 may be configured to automatically generate different action routine for stocking the warehouse 2 with spare parts 4, wherein the action routines may differ from each other in one or both of the list of spare parts needed for the warehouse 2 and/or the procedural instructions to procure spare parts 4 of the list of spare parts 4 needed and/or the transport mechanisms (e.g., via drone and/or automated vehicle). Each of the different action routines may be designed, as indicated, for a specific time. The specific time may be a pre-harvest period, a harvest period or a post-harvest period. As in the harvest period, procurement of spare parts 4 may need to be as fast as possible due to the fact that the one or more agricultural machines 5 are operating all day long and a machine downtime would result in significant economic losses for the user 22, the procedural instructions for the harvest period may be designed under the premise that procurement of spare parts 4 needs to be performed faster than in the pre-harvest period and the post-harvest period.

Thus, via the module 14, it may be possible to provide a holistic approach for managing a stocking of a warehouse 2 on a farm 3 with spare parts 4 for one or more agricultural machines 5 of a fleet 6 of agricultural machines 5. Efficient management may be performed by having the ability to automatically access different information and/or criteria 15 defining the global ecosystem for operating the warehouse 2. A service provider, spare part dealer, manufacturer or the like may be able to obtain access to the module 14 and to interact with the module 14 via a computational device 9 in order to plan, coordinate and supervise a stocking of the warehouse 2 on a digital level and therefore highly efficient.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 System for managing a stocking of a warehouse
2 Warehouse
3 Farm
4 Spare part
5 Agricultural machine
6 Fleet
7 Server
8 Database
9 Computational device
10 Network
11 Processing device
12 Processor
13 Memory
14 Module
15 Information and/or criteria regarding a stocking of a warehouse
16 Central storage
17 Neighboring warehouse
18 Neighboring farm
19 Part runner
20 Drone
21 Country or region
22 User
23 User end device
24 Sensor arrangement

1. A system configured to manage stocking a warehouse on a farm with spare parts for at least one agricultural machine of a fleet, the system comprising:
at least one server;
at least one database; and
at least one computational device;
wherein the at least one server, the at least one database, and the at least one computational device are configured to communicate via one or more networks;
wherein the at least one database is configured to store a module and one or both of information regarding the stocking of the warehouse or criteria regarding the stocking of the warehouse, wherein the module is configured to plan technical service for the at least one agricultural machine;
wherein the at least one server is configured to host the module for the at least one computational device;
wherein, upon execution of the module by the computational device, the module is configured to automatically coordinate and automatically supervise the stocking of the warehouse with spare parts based on one or both of the information regarding the stocking of the warehouse or the criteria regarding the stocking of the warehouse.

2. The system of claim 1, wherein the module is configured to automatically plan, automatically coordinate, and automatically supervise the stocking of the warehouse with spare parts based on an initial stock of the spare parts in the warehouse for operation of the at least one agricultural machine during a respective time period, in particular a harvest season or an entire calendar year; and
wherein the module is configured to automatically determine the initial stock based on the one or both of the information regarding the stocking of the warehouse or the criteria regarding the stocking of the warehouse.

3. The system of claim 1, wherein the module is configured to automatically generate at least one action routine for stocking the warehouse with the spare parts;
wherein the action routine comprises a list of spare parts needed for the warehouse and procedural instructions to procure spare parts contained in the list; and
wherein the module is configured to automatically generate the action routine based on the one or both of the information regarding the stocking of the warehouse or the criteria regarding the stocking of the warehouse.

4. The system of claim 3, further comprising one or more automated vehicles configured to, responsive to the list of spare parts, automatically transport one or more of the spare parts on the list.

5. The system of claim 3, wherein the action routine is automatically generated based on spare part availability in a vicinity of the warehouse.

6. The system of claim 3, wherein the module is configured to automatically monitor entry of the spare parts into the warehouse and dispatch of the spare parts from the warehouse; and
wherein responsive to automatically determining the dispatch of the spare parts from the warehouse, the module is configured to automatically instruct and automatically trigger the procedural instructions to automatically procure the spare parts.

7. The system of claim 5, wherein the module is configured to automatically modify the action routine responsive to automatically determining a dispatch of the spare parts from the warehouse.

8. The system of claim 3, wherein the module is configured to automatically instruct and automatically trigger the procedural instructions to procure the spare parts responsive to receiving a request for the spare parts initiated by one or both of a user of the warehouse or the at least one agricultural machine.

9. The system of claim 3, wherein the module is configured to automatically monitor a wear condition of the at least one agricultural machine based on the one or both of the information regarding the stocking of the warehouse or the criteria regarding the stocking of the warehouse; and
wherein the module is configured to automatically generate the action routine based on the monitored wear condition of the at least one agricultural machine to procure the spare parts.

10. The system of claim 3, wherein the module is configured to:
automatically access a predetermined time frame; and
automatically generate the action routine for procurement of the spare parts within the predetermined time frame; and
further comprising one or more automated vehicles configured to, responsive to the list of spare parts, automatically transport one or more of the spare parts on the list within the predetermined time frame.

11. The system of claim 3, wherein the module is configured to automatically generate different action routines for stocking the warehouse with spare parts;
wherein the different actions routines differ from each other in one or both of the list of spare parts needed for the warehouse or the procedural instructions to procure spare parts of the list of spare parts;
wherein each action routine is designed for a specific respective time; and
wherein the specific respective time comprises a pre-harvest period, a harvest period or a post-harvest period.

12. The system of claim 11, wherein the module is configured to:
automatically determine whether the specific respective time is the pre-harvest period, the harvest period or the post-harvest period; and
automatically generate the procedural instructions of the action routine so that the procurement of the spare parts during the harvest period is faster than during the pre-harvest period and post-harvest period.

13. The system of claim 1, wherein the one or both of the information regarding the stocking of the warehouse or the criteria regarding the stocking of the warehouse are related to one or more of: the warehouse; the at least one agricultural machine; at least one central storage for the spare parts; at least one neighboring warehouse for the spare parts on a neighboring farm; one or more part runners; or one or more drones for transportation of the spare parts between different facilities and entities.

14. The system of claim 13, wherein one or more of the at least one server, the at least one database, or the at least one computational device are configured to communicate, via the one or more networks, with one or more of the warehouse, the at least one agricultural machine, the at least one central storage, the at least one neighboring warehouse, the one or more part runners, or the one or more drones in order to provide the one or both of the information regarding the stocking of the warehouse or the criteria regarding the stocking of the warehouse to the at least one database.

15. The system of claim 13, wherein the one or both of the information regarding the stocking of the warehouse or the criteria regarding the stocking of the warehouse comprise one or more of:
information regarding one or both of a geographic position or an actual stock of the warehouse;
criteria regarding the stock of the warehouse;
information regarding a configuration of the at least one agricultural machine;
information regarding an operation of the at least one agricultural machine;
information regarding crops harvested by the at least one agricultural machine;
information regarding agronomic conditions at the geographical position of the warehouse;
information regarding climatic conditions at the geographical position of the warehouse;
information regarding one or both of a geographical position or an actual stock of the at least one central storage;
information regarding one or both of the geographical position or the actual stock of the at least one neighboring warehouse; or
information regarding one or more of the geographical position, an availability, or a capacity of one or more of the one or more part runners or the one or more drones.

16. The system of claim 1, wherein at least some of the information regarding the stocking of the warehouse or the criteria regarding the stocking of the warehouse is definable by one or more of a user of the warehouse, a service provider, one or both of a spare part dealer or a manufacturer of the spare parts, or the at least one agricultural machine.

17. The system of claim 16, wherein one or more of the at least one server, the at least one database, or the at least one computational device are configured to communicate with at least one user end device in order to transmit the at least some of the information regarding the stocking of the warehouse or the criteria regarding the stocking of the warehouse.

18. A method for managing stocking of a warehouse on a farm with spare parts for at least one agricultural machine of a fleet, the method comprising:
using a system, the system including at least one server, at least one database, and at least one computational device, wherein the at least one server, the at least one database, and the at least one computational device communicate via one or more networks, wherein the at least one database stores a module and one or both of information regarding the stocking of the warehouse or criteria regarding the stocking of the warehouse, wherein the module automatically plans technical service for the at least one agricultural machine, wherein the at least one server hosts the module for the at least one computational device; and
upon execution of the module by the computational device, the module automatically coordinates and automatically supervises the stocking of the warehouse with spare parts based on one or both of the information regarding the stocking of the warehouse or the criteria regarding the stocking of the warehouse.

19. The method of claim 18, wherein the module automatically plans, automatically coordinates, and automatically supervises the stocking of the warehouse with spare parts based on an initial stock of the spare parts in the warehouse for operation of the at least one agricultural machine during a respective time period, in particular a harvest season or an entire calendar year; and
wherein the module automatically determines the initial stock based on the one or both of the information regarding the stocking of the warehouse or the criteria regarding the stocking of the warehouse.

20. The method of claim 19, wherein the module automatically generates at least one action routine for stocking the warehouse with the spare parts;
wherein the action routine comprises a list of spare parts needed for the warehouse and procedural instructions to procure spare parts contained in the list;
wherein the module automatically generates the action routine based on the one or both of the information regarding the stocking of the warehouse or the criteria regarding the stocking of the warehouse; and
further comprising one or more automated vehicles that, responsive to the list of spare parts, automatically transport one or more of the spare parts on the list.
